(19) United States
(12) Patent Application Publication
(10) Pub. No.: US 2026/0261415 A1
(43) Pub. Date: Sep. 3, 2026

(54) Multi-Choice Authentication for Data Recovery

(71) Applicant: Dell Products L.P., Round Rock, TX (US)

(72) Inventor: Chetan Ramchandra Kulkarni, Pune (IN)

(21) Appl. No.: 19/067,646

(22) Filed: Feb. 28, 2025

(51) Int. Cl. H04L 9/08

(52) U.S. Cl. CPC H04L 9/088

(57) ABSTRACT

A system can encrypt data of a self-encrypting drive with a media encryption key. The system can encrypt the media encryption key with an authentication key and a recovery key, wherein the media encryption key is able to be decrypted with either the authentication key or the recovery key. The system can store a first value that indicates a maximum number of permitted failed attempts to access the data, and store a second value that indicates a number of failed access attempts. The system can, where the first value is greater than the second value, deny a first attempt to access the data of the self-encrypting drive with the recovery key, and permit a second attempt to access the data of the self-encrypting drive with the authentication key. The system can, where the first value is not greater than the second value, allow the first attempt to access the data.

### BACKGROUND

Data on a storage device can be encrypted, or otherwise protected.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can encrypt data of a self-encrypting drive with a media encryption key that is stored on the self-encrypting drive. The system can encrypt the media encryption key with an authentication key. The system can encrypt the media encryption key with a recovery key, wherein the media encryption key is able to be decrypted with either the authentication key or the recovery key. The system can store, on the self-encrypting drive, a first value that indicates a maximum number of permitted failed attempts to access the data of the self-encrypting drive. The system can store, on the self-encrypting drive, a second value that indicates a number of failed attempts made to access the data on the self-encrypting drive. The system can, in a first case where the first value is determined to be greater than the second value, deny a first attempt to access the data of the self-encrypting drive with the recovery key, and permit a second attempt to access the data of the self-encrypting drive with the authentication key. The system can, in a second case where the first value is determined not to be greater than the second value, allow the first attempt to access the data of the self-encrypting drive with the recovery key.

An example method can comprise encrypting, by a system comprising at least one processor, a media encryption key with an authentication key, wherein the media encryption key encrypts data of a self-encrypting drive, and wherein the media encryption key is stored on the self-encrypting drive. The method can further comprise encrypting, by the system, the media encryption key with a recovery key, wherein either the authentication key or the recovery key is usable to decrypt the media encryption key. The method can further comprise storing, by the system, a first value of a maximum number of permitted failed attempts to access the data of the self-encrypting drive, and a second value of a number of failed attempts made to access the data on the self-encrypting drive. The method can further comprise, in response to determining that the first value is greater than the second value, denying, by the system, an attempt to access the data of the self-encrypting drive with the recovery key. The method can further comprise, in response to determining that the first value is not greater than the second value, allowing, by the system, the attempt to access the data of the self-encrypting drive with the recovery key.

An example non-transitory computer-readable medium can comprise instructions that, in response to execution, cause a system comprising a processor to perform operations. These operations can comprise encrypting a first key with a second key, wherein the first key is usable to encrypt data of a storage device. These operations can further comprise encrypting the first key with a third key, wherein the first key is able to decrypted with either the second key or the third key. These operations can further comprise storing a first value representative of an upper limit on number of permitted failed attempts to access the data of the storage device, and a second value representative of a number of failed attempts that have been made to access the data on the storage device. These operations can further comprise, based on the first value being determined to be greater than the second value, denying an attempt to access the data of the storage device with the third key. These operations can further comprise based on the first value being determined not to be greater than the second value, allowing the attempt to access the data of the storage device with the third key.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate multi-choice authentication for data recovery, in accordance with an embodiment of this disclosure;

FIG. 2 illustrates an example of using an authentication key with a self-encrypting drive, in accordance with an embodiment of this disclosure;

FIG. 3 illustrates another example of using an authentication key with a self-encrypting drive, in accordance with an embodiment of this disclosure;

FIG. 4 illustrates an example of storing an authentication key for a self-encrypting drive with multiple entities, in accordance with an embodiment of this disclosure;

FIG. 5 illustrates another example of storing an authentication key for a self-encrypting drive with multiple entities, in accordance with an embodiment of this disclosure;

FIG. 6 illustrates an example that can facilitate multi-choice authentication for data recovery, in accordance with an embodiment of this disclosure;

FIG. 7 illustrates an example that can facilitate multi-choice authentication for data recovery, in accordance with an embodiment of this disclosure;

FIG. 8 illustrates an example that can facilitate multi-choice authentication for data recovery, in accordance with an embodiment of this disclosure;

FIG. 9 illustrates an example process flow that can facilitate multi-choice authentication for data recovery, in accordance with an embodiment of this disclosure;

FIG. 10 illustrates another example process flow that can facilitate multi-choice authentication for data recovery, in accordance with an embodiment of this disclosure;

FIG. 11 illustrates another example process flow that can facilitate multi-choice authentication for data recovery, in accordance with an embodiment of this disclosure;

FIG. 12 illustrates an example block diagram of a computer operable to execute an embodiment of this disclosure.

### DETAILED DESCRIPTION

### Overview

A self-encrypting drive (SED) generally comprises a type of computer hard drive that provides hardware-based encryption to protect sensitive data. A SED can comprise a media encryption key (MEK), which comes to life once SED is powered on. This MEK can be used to encrypt and decrypt data as it is written to and read from the SED, respectively. The MEK can provide an encryption capability but not protection—that is, it can be that, if someone removes the SED from one system and plugs into another system; then that person can read the SED's data.

Hence, SED systems can also make use of an authentication key (AK), which can comprise a wrapper over a MEK. An AK can be implemented to avoid a SED-drive-theft issue.

When a SED is configured with AK, and upon power off/on, the SED drive can go to a locked state. It can be that the SED can be unlocked only if a user provides a valid AK. Thus, an AK can be part of the SED's security mechanism, as it can be used to unlock the drive and allow access to the encrypted data. Without the AK, it can be that the data on the drive remains inaccessible and cannot be recovered, making it an aspect of the SED's security architecture.

This can be expressed as: SED data-at-rest->MEK (to encrypt SED data)->AK (to encrypt MEK to protect SED data).

In prior SED implementations, a single AK can be used to lock the SED drive and prevent unauthorized access. However, this prior approach can create a problem of a single point of failure, as if the AK is lost, forgotten, or unknown, the SED's data can become unavailable and cannot be recovered. That is, if the AK is lost or forgotten, the data on the SED can become irrecoverable (because the AK is used to retrieve the MEK, which in turn is used to retrieve SED data), leading to a situation of SED data unavailability (DU).

The present techniques can be implemented to address this DU issue via a fallback mechanism that can ensure data recovery in case the AK is lost or unknown.

The following are two example implementations of a fallback mechanism:
1. A multi-choice authentication implementation, where one extra key (referred to as a recovery key (RK)) is maintained to recover SED data in an absence of an AK. This can be referred to as multi-choice authentication (MCA).
2. Storing the AK itself with authorized personnel (who can be other than the SED owner).

In MCA:
1. Instead of just one AK, an RK can be added as an extra key (to be used as a fallback key as an alternate to an AK key) and it can be used to retrieve a MEK, so that user data on the SED can be accessible in case the AK is lost.
2. TCG protocols or SCSI security PROTOCOL IN/OUT commands can be used, which can act an interface between a SED host system and an actual SED drive. They can be used to configure/set security settings on SED disk.
3. These protocols or commands can be used to set multiple keys for the SED. While setting an authentication key for a SED, instead of setting one AK, a list of more than one AK can be set (e.g., [AK, RK]).
4. This can involve a change in implementation of getting and setting an AK for a SED, relative to prior approaches.
5. This can also involve a change (relative to prior approaches) in implementation logic of comparing a future “input AK” from the SED host system to unlock the drive. It can be that, according to the present techniques, the input AK is compared one by one with each key present in the list (i.e., [AK, RK]), as opposed to a prior approach where only one AK is compared.
6. This can be distinguished from a multi-factor authentication solution (which can require that all factors pass, as in an AND operation—e.g., auth1 AND auth2 AND . . . ). Instead, this comprises a multi-choice authentication type mechanism (where it is sufficient for either of the authentication schemes to work) in priority order. For examples, check against a first AK, if the first AK fails for a configurable number of attempts, then check against the RK (which can be expressed as, auth1-AK OR auth2-RK).
7. It can be that rekeying (that is, changing the AK) would require the old AK to set the new AK, and the present techniques consider a scenario where the AK is lost, invalid, unknown, etc.

In an implementation where an AK is secured/saved with another authorized person along with a SED owner,
1. A copy of the AK can be saved with someone else (e.g., authorized personnel, security/professional assurance services (PAS) team within the organization, etc.) who is different from the SED system owner.
2. This AK with authorized personnel can be used in a case of emergency and can be a form of a fallback mechanism for the AK.
3. The AK can be saved with authorized personnel in an unmodified form. In some examples, the AK can be saved in a secured format, such as by encrypting the AK by authorized personnel and saving it as a RK.
4. In this scenario, it can be that a RK for the SED is not saved on the SED. Instead, it can be kept with authorized personnel, e.g., in email/vault.
5. It can be that, according to the present techniques, the internals of SEDs are not modified to save more than one AK to retrieve a MEK. Thus, this can ensure that prior standards or implementations of SED regulations and protocols can be adhered to as part of implementing the present techniques.

The following can be implemented to ensure that the fallback mechanism (e.g., RK or authorized personnel) do not become a primary mechanism. A logical check can be implemented to ensure that the RK is used only when the AK is lost or unavailable. This can be achieved by storing a flag or a counter on the SED that indicates whether the AK is available.

To ensure that the RK is used only when it is confirmed that AK is really lost/unknown/invalid (that is, not using the RK as the primary mechanism), an existing SED counter can be leveraged: tryLimit=10. This can be a configurable counter that defines and accepts maximum invalid authentication attempts with AK. This counter can be used to implement an additional check to ensure that the AK is not compromised. This can be done by tracking the number of times that the AK is used and checking if the value is within a certain threshold. The following is an example of how this counter can be implemented:
1. When the AK is used to decrypt the MEK, the SED can increment a counter to track the number of times the AK is used.
2. If the counter reaches a certain threshold, (e.g., 10 times), the SED can treat the AK as invalid and the AK can be considered to be lost/unknown/invalid. Then a fallback mechanism can be invoked, where the RK can be used to recover the MEK.
3. The RK can then be used to recover the MEK and decrypt the data.

By implementing this additional check, efforts can be made to ensure that the RK is only used when the AK is truly lost or unavailable and an attacker can be prevented from using the RK as the primary mechanism.

The present techniques provide a robust fallback mechanism to recover data on SEDs in case the AK is lost or unavailable. By introducing a logical check to ensure that the RK is used only when the AK is unavailable, the fallback mechanism can be prevented from becoming the primary mechanism, while still providing a reliable means of data recovery.

This fallback mechanism can aid data recovery by ensuring that data recovery is possible in a case where an AK is lost or forgotten. The present techniques can reduce a risk of data unavailability and ensures that data remains secure.

### Example Architectures, Etc.

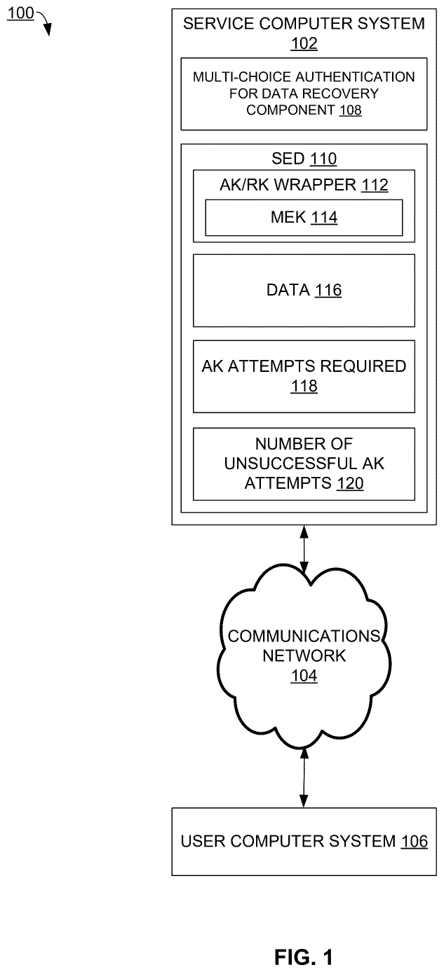

FIG. 1 illustrates an example system architecture 100 that can facilitate multi-choice authentication for data recovery, in accordance with an embodiment of this disclosure.

System architecture 100 comprises computer system 102, communications network 104, and user computer system 106. Computer system 102 comprises multi-choice authentication for data recovery component 108, and SED 110. In turn, SED 110 comprises AK/RK wrapper 112, MEK 114, data 116, AK attempts required 118, and number of unsuccessful AK attempts 120.

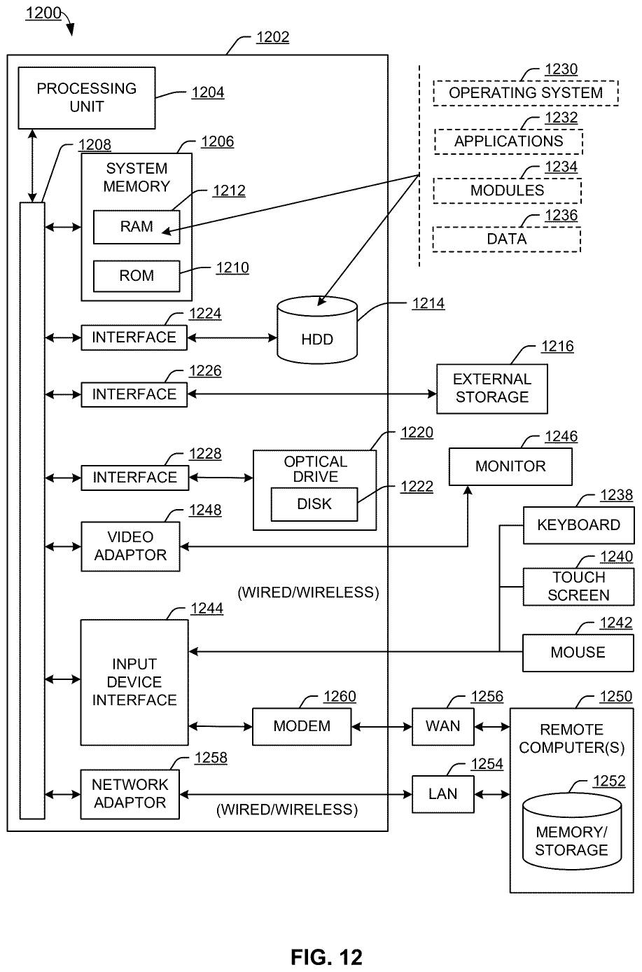

Each of computer system 102 and/or user computer system 106 can be implemented with part(s) of computing environment 1200 of FIG. 12. Communications network 104 can comprise a computer communications network, such as the Internet.

Multi-choice authentication for data recovery component 108 can effectuate multi-choice authentication on SED 110, where either an AK or a RK can be used to decode MEK 114 (where AK/RK wrapper 112 indicates that MEK 114 is encoded and can be decoded with either of AK or RK). In turn, MEK 114 encodes data 116.

In some examples, an RK cannot be used until a given number of unsuccessful attempts to use the AK have first been made (at which point, the AK can be considered to be lost). This given number of unsuccessful attempts to use the AK is stored in AK attempts required 118, and the number of unsuccessful attempts to use the AK made so far is stored in number of unsuccessful AK attempts 120.

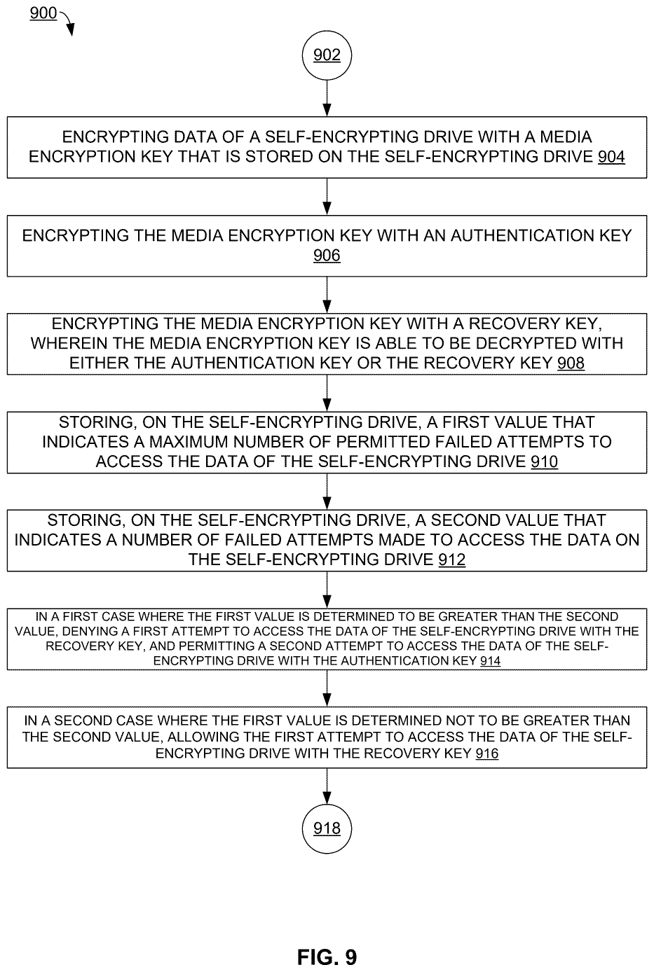

In some examples, multi-choice authentication for data recovery component 108 can implement part(s) of the process flows of FIGS. 9-11 to implement multi-choice authentication for data recovery.

It can be appreciated that system architecture 100 is one example system architecture for multi-choice authentication for data recovery, and that there can be other system architectures that facilitate multi-choice authentication for data recovery.

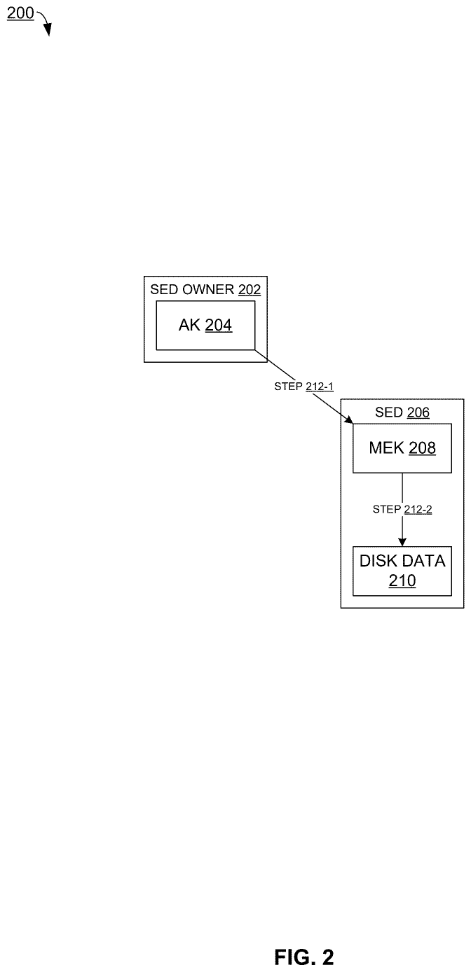

FIG. 2 illustrates an example 200 of using an authentication key with a self-encrypting drive, in accordance with an embodiment of this disclosure. In some examples, part(s) of example 200 can be implemented by part(s) of system architecture 100 of FIG. 1.

Example 200 comprises SED owner 202, AK 204, SED 206, MEK 208, disk data 210, step 212-1, and step 212-2.

In example 200, AK 204 is available. At step 212-1, AK 204 is used to decode MEK 208, and at step 212-2, MEK 208 is used to decode disk data 210.

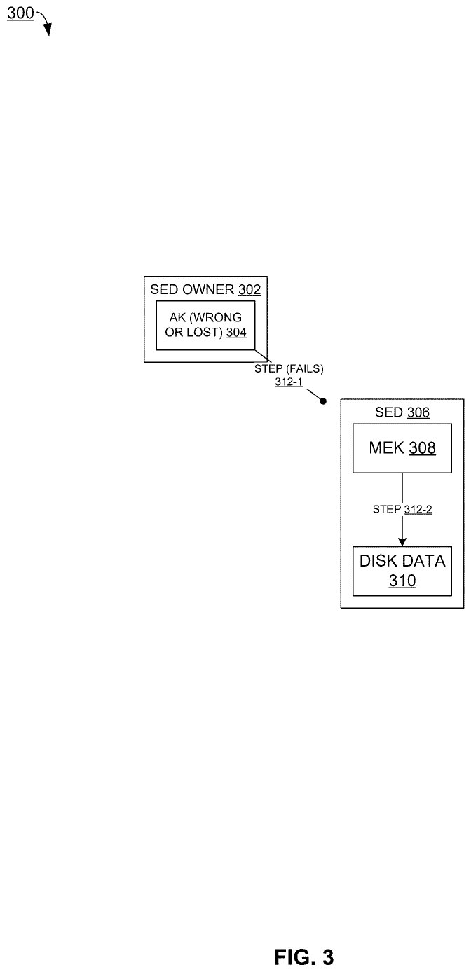

FIG. 3 illustrates another example 300 of using an authentication key with a self-encrypting drive, in accordance with an embodiment of this disclosure. In some examples, part(s) of example 300 can be implemented by part(s) of system architecture 100 of FIG. 1.

Example 300 comprises SED owner 302, AK (wrong or lost) 304, SED 306, MEK 308, disk data 310, step (fails) 312-1, and step 312-2.

In contrast to example 200 (where AK 204 is available), in example 300, AK (wrong or lost) 304 is unavailable. So, at step (fails) 312-1, the correct AK is not provided to decode MEK 308, so the MEK is not decoded and used to decode disk data 310 at step 312-2.

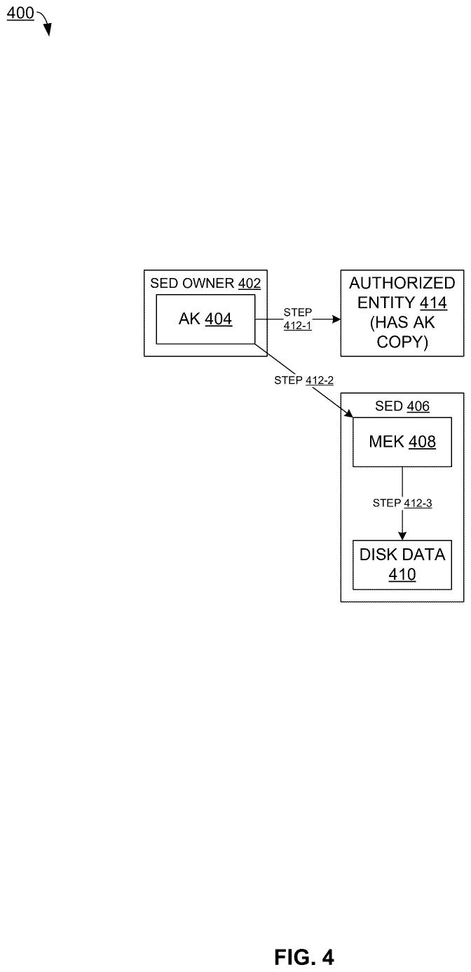

FIG. 4 illustrates an example 400 of storing an authentication key for a self-encrypting drive with multiple entities, in accordance with an embodiment of this disclosure. In some examples, part(s) of example 400 can be implemented by part(s) of system architecture 100 of FIG. 1.

Example 400 comprises SED owner 402, AK 404, SED 406, MEK 408, disk data 410, step 412-1, step 412-2, step 412-3, and authorized entity 414.

In example 400, at step 412-1, SED owner 402 shares a copy of AK 404 with authorized entity 414. Also in example 400, SED owner 402 does not lose its copy of AK 404, so can use AK 404 to access disk data 410 itself: at step 412-2, it uses AK 404 to decode MEK 408, and at step 412-3, it uses the decoded MEK 408 to decode disk data 410.

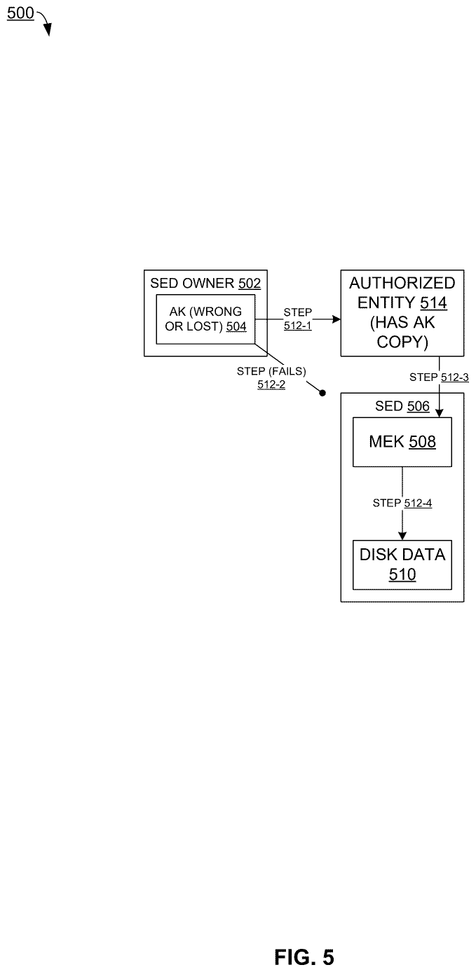

FIG. 5 illustrates another example 500 of storing an authentication key for a self-encrypting drive with multiple entities, in accordance with an embodiment of this disclosure. In some examples, part(s) of example 500 can be implemented by part(s) of system architecture 100 of FIG. 1.

Example 500 comprises SED owner 502, AK (wrong or lost) 504, SED 506, MEK 508, disk data 510, step 512-1, step (fails) 512-2, step 512-3, step 512-4, and authorized entity 514.

In contrast to example 400 of FIG. 4, where SED owner 402 uses AK 404 to access disk data 410, here SED owner 502 lacks the correct AK, where AK (wrong or lost) 504 is invalid. Instead, a copy of AK stored with authorized entity 514 is used.

In example 500, at step 512-1, SED owner 502 shares a copy of AK 504 with authorized entity 514. At step 512-2, SED owner 502 is unable to use AK (wrong or lost) 504 to decode MEK 508. At step 512-3, authorized entity 514 uses its copy of the AK to decode MEK 508. At step 512-4, the decoded MEK 508 is used to decode disk data 510.

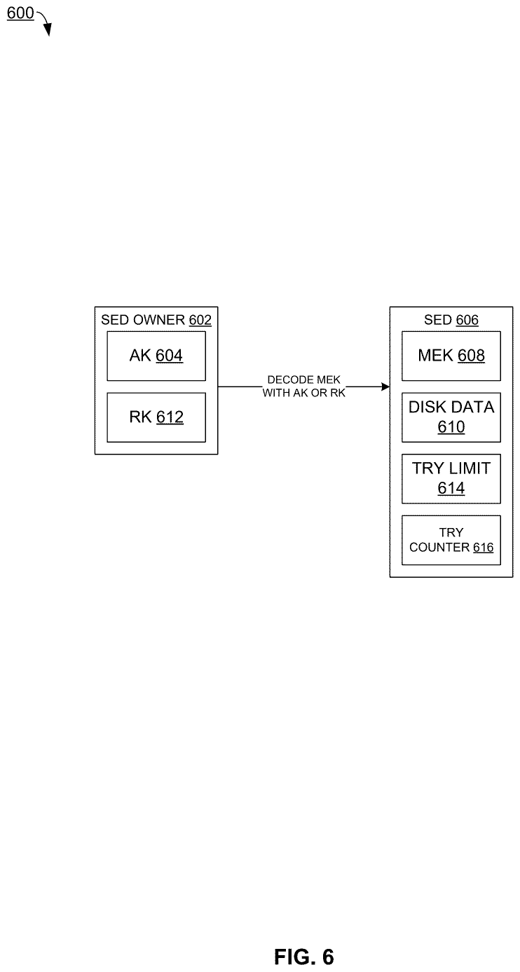

FIG. 6 illustrates an example 600 that can facilitate multi-choice authentication for data recovery, in accordance with an embodiment of this disclosure. In some examples, part(s) of example 600 can be implemented by part(s) of system architecture 100 of FIG. 1.

Example 600 comprises SED owner 602, AK 604, SED 606, MEK 608, disk data 610, RK 612, try limit 614, and try counter 616.

In example 600, SED owner 602 has both AK 604 and RK 612, and either of AK 604 or RK 612 can be used to decode MEK 608 (which can be used to decode disk data 610). This alternate use of either AK 604 or RK 612 is a form of multi-choice authentication.

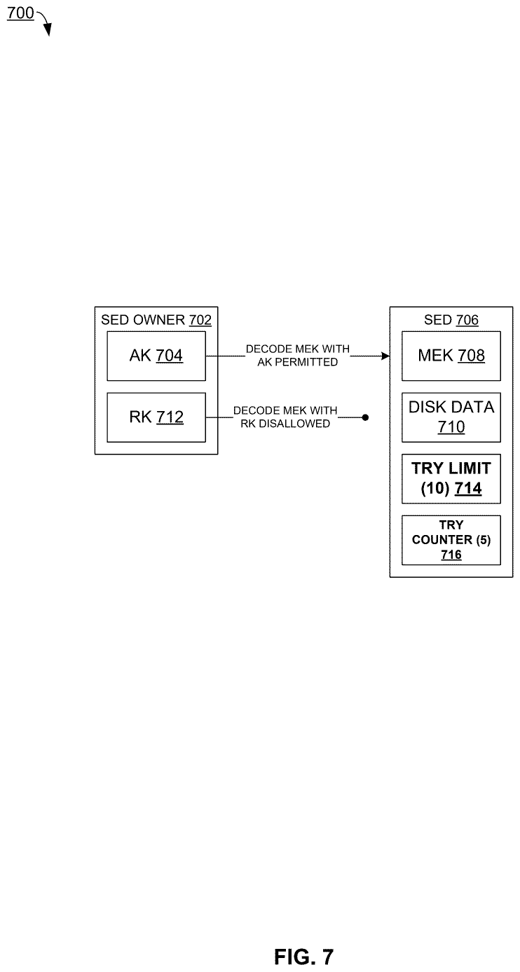

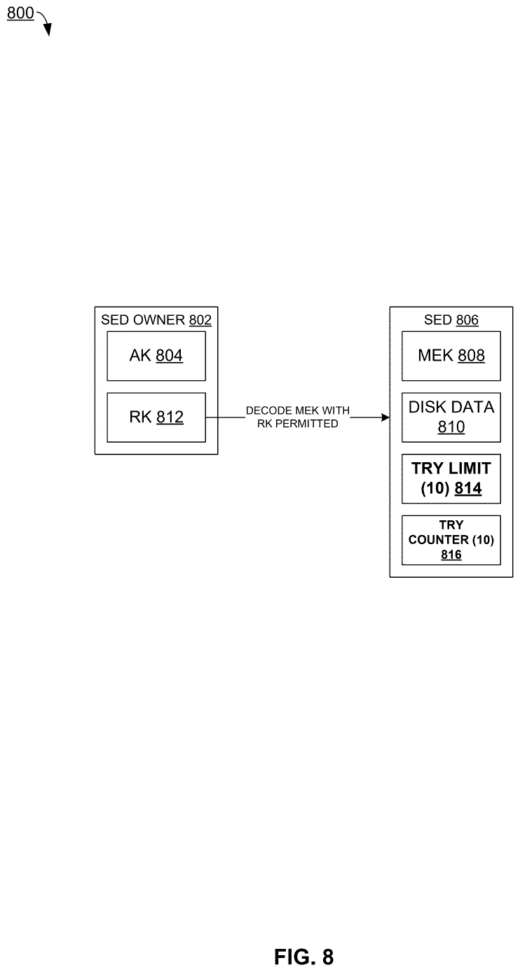

Try limit 614 and try counter 616 can comprise a configurable number of unsuccessful tries with the AK before the RK can be used, and the number of unsuccessful tries identified, respectively. Examples of different values for a try counter 616 illustrated with respect to example 700 of FIG. 7 and example 800 of FIG. 8.

FIG. 7 illustrates an example 700 that can facilitate multi-choice authentication for data recovery, in accordance with an embodiment of this disclosure. In some examples, part(s) of example 700 can be implemented by part(s) of system architecture 100 of FIG. 1.

Example 700 comprises SED owner 702, AK 704, SED 706, MEK 708, disk data 710, RK 712, try limit (10) 714, and try counter (5) 716.

In example 700, SED owner 702 has both AK 704 and RK 712, and either of AK 704 or RK 712 can be used to decode MEK 708 (which can be used to decode disk data 710). This alternate use of either AK 704 or RK 712 is a form of multi-choice authentication.

However, RK 712 can be used only when there first have been enough invalid attempts to use an AK. In this example, try limit (10) 714 indicates that RK 712 can be used after 10 unsuccessful AK attempts, and try counter (5) 716 indicates that only 5 such attempts have been made.

So, example 700 illustrates a point where AK 704 could be successfully used, but RK 712 cannot yet be used.

FIG. 8 illustrates an example 800 that can facilitate multi-choice authentication for data recovery, in accordance with an embodiment of this disclosure. In some examples, part(s) of example 800 can be implemented by part(s) of system architecture 100 of FIG. 1.

Example 800 comprises SED owner 802, AK 804, SED 806, MEK 808, disk data 810, RK 812, try limit (10) 814, and try counter (10) 816.

In example 800, SED owner 802 has both AK 804 and RK 812, and either of AK 804 or RK 812 can be used to decode MEK 808 (which can be used to decode disk data 810). This alternate use of either AK 804 or RK 812 is a form of multi-choice authentication.

In contrast to example 700 of FIG. 7 (where there have not been enough unsuccessful AK attempts for a RK to be used), in this example, try limit (10) 814 indicates that RK 812 can be used after 10 unsuccessful AK attempts, and try counter (10) 816 indicates that those 10 attempts have been made. So, AK 804 can be considered lost (and no longer valid for decoding MEK 808), and RK 812 can be used to decode MEK 808.

In some examples, where an AK is lost, the RK becomes the new AK, and a new RK is determined (such as based on user input data). In some examples, where a successful AK decode is made (or the AK is assigned a new value), the try counter is reset.

### Example Process Flows

FIG. 9 illustrates an example process flow 900 that can facilitate multi-choice authentication for data recovery, in accordance with an embodiment of this disclosure. In some examples, one or more embodiments of process flow 900 can be implemented by multi-choice authentication for data recovery component 108 of FIG. 1, or computing environment 1200 of FIG. 12.

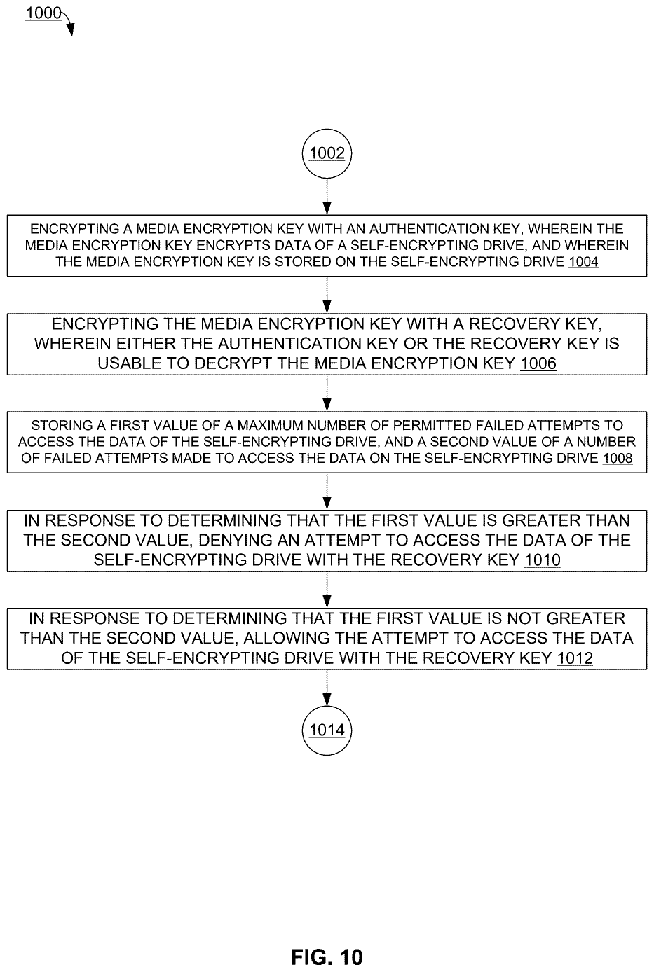

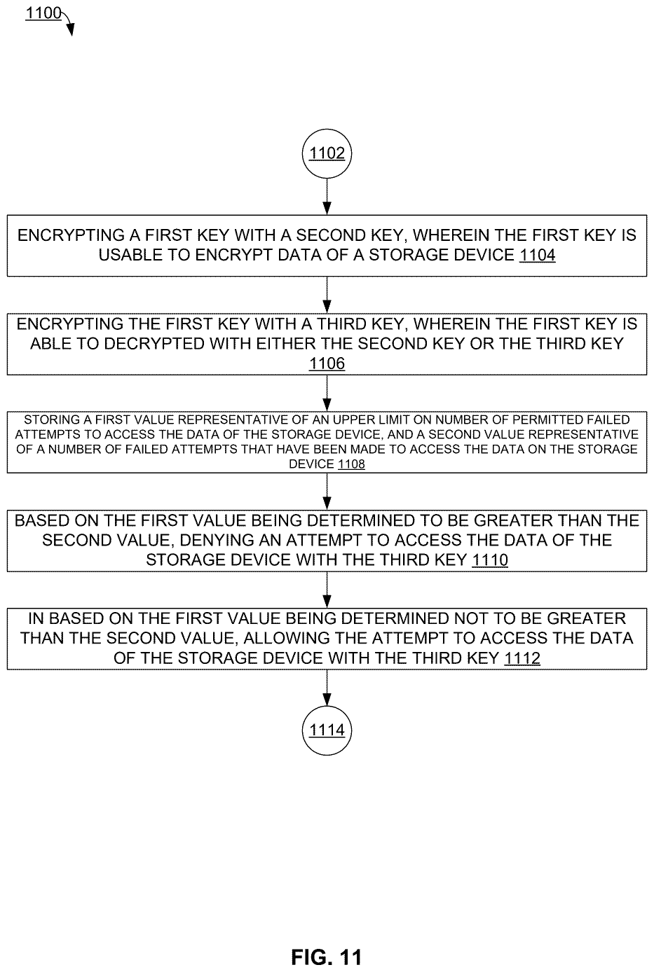

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 1000 of FIG. 10, and/or process flow 1100 of FIG. 11.

Process flow 900 begins with 902, and moves to operation 904.

Operation 904 depicts encrypting data of a self-encrypting drive with a media encryption key that is stored on the self-encrypting drive. Using the example of FIG. 1, this can be data 116 on SED 110 that is encrypted with MEK 114.

After operation 904, process flow moves to operation 906.

Operation 906 depicts encrypting the media encryption key with an authentication key. Using the example of FIG. 6, the authentication key can be AK 604.

After operation 906, process flow moves to operation 908.

Operation 908 depicts encrypting the media encryption key with a recovery key, wherein the media encryption key is able to be decrypted with either the authentication key or the recovery key. Using the example of FIG. 6, the recovery key can be RK 604.

After operation 908, process flow moves to operation 910.

Operation 910 depicts storing, on the self-encrypting drive, a first value that indicates a maximum number of permitted failed attempts to access the data of the self-encrypting drive. Using the example of FIG. 1, the first value can be AK attempts required 118.

After operation 910, process flow moves to operation 912.

Operation 912 depicts storing, on the self-encrypting drive, a second value that indicates a number of failed attempts made to access the data on the self-encrypting drive. Using the example of FIG. 1, the second value can be number of unsuccessful AK attempts 120.

After operation 912, process flow moves to operation 914.

Operation 914 depicts, in a first case where the first value is determined to be greater than the second value, denying a first attempt to access the data of the self-encrypting drive with the recovery key, and permitting a second attempt to access the data of the self-encrypting drive with the authentication key. This can be similar to as depicted with respect to example 700 of FIG. 7.

In some examples, the denying of the first attempt to access the data of the self-encrypting drive with the recovery key comprises incrementing the second value. That is, using the example of FIG. 1, on an unsuccessful attempt to access data 116 of SED 110 with an AK, the value of number of unsuccessful AK attempts 120 can be incremented (i.e., it can be increased by 1).

In some examples, the permitting of the second attempt to access the data of the self-encrypting drive with the authentication key comprises resetting the second value. That is, using the example of FIG. 1, a successful use of the authentication key can cause the value of number of unsuccessful AK attempts 120 to be reset (i.e., changed to equal zero).

After operation 914, process flow moves to operation 916.

Operation 916 depicts, in a second case where the first value is determined not to be greater than the second value, allowing the first attempt to access the data of the self-encrypting drive with the recovery key. This can be similar to as depicted with respect to example 800 of FIG. 8.

In some examples, the allowing of the first attempt to access the data of the self-encrypting drive with the recovery key comprises rendering the authentication key invalid for use in accessing the data of the self-encrypting drive. That is, where enough unsuccessful attempts are made to access the data of a SED with an AK, the AK can be rendered invalid for accessing the data of the SED. This number of unsuccessful attempts can be the value of AK attempts required 118 of FIG. 1.

In some examples, the authentication key is a first authentication key, and operation 916 comprises, based on the recovery key, generating a second authentication key that is valid for use in accessing the data of the self-encrypting drive. This second authentication key can be a new value for the authentication key, and can replace the previous authentication key/first authentication key. In some examples, the recovery key's value becomes the new authentication key's value.

In some examples, the recovery key is a first recovery key, and operation 916 comprises, after generating the second authentication key, generating a second recovery key, and replacing the first recovery key with the second recovery key. That is, a new recovery key value (the second recovery key) can replace a prior recovery key value (the first recovery key), such as when the prior recovery key value is now used for the authentication key's value.

In some examples, the generating of the second recovery key is based on a third value received via user input. That is, a user can specify what the new recovery key value is, such as by providing user input of the same.

After operation 916, process flow moves to 918, where process flow 900 ends.

FIG. 10 illustrates an example process flow 1000 that can facilitate multi-choice authentication for data recovery, in accordance with an embodiment of this disclosure. In some examples, one or more embodiments of process flow 1000 can be implemented by multi-choice authentication for data recovery component 108 of FIG. 1, or computing environment 1200 of FIG. 12.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 900 of FIG. 9, and/or process flow 1100 of FIG. 11.

Process flow 1000 begins with 1002, and moves to operation 1004.

Operation 1004 depicts encrypting a media encryption key with an authentication key, wherein the media encryption key encrypts data of a self-encrypting drive, and wherein the media encryption key is stored on the self-encrypting drive. In some examples, operation 1004 can be implemented in a similar manner as operations 904-906 of FIG. 9.

In some examples, operation 1004 comprises encrypting at least a first portion of the data with the media encryption key when writing the at least the first portion of the data to the self-encrypting drive, and decrypting at least a second portion of the data with the media encryption key when reading the at least the second portion of the data to the self-encrypting drive. That is, a MEK can be used to encrypt data as it is written to a SED, and decrypt data as it is read from the SED.

In some examples, the system is a first storage system, and functionality to offer data protection using the media encryption key is disabled when the self-encrypting drive is moved from the first storage system to a second storage system. That is, a MEK can provide encryption capability but not protection. The lack of protection can entail, if someone removes a SED from one system and plugs it into another system, it can be that the data can be read from the SED despite the MEK being set.

After operation 1004, process flow 1000 moves to operation 1006.

Operation 1006 depicts encrypting the media encryption key with a recovery key, wherein either the authentication key or the recovery key is usable to decrypt the media encryption key. In some examples, operation 1006 can be implemented in a similar manner as operation 908 of FIG. 9.

In some examples, operation 1006 comprises, based on powering on the self-encrypting drive, locking the self-encrypting drive, and, in response to receiving the authentication key, unlocking the self-encrypting drive. That is, when a SED is configured with an AK, upon power on, the SED can enter a Locked state, and can be unlocked where a user account provides a valid AK.

In some examples, operation 1006 comprises setting the authentication key and the recovery key for the self-encrypting drive based on a trusted computing group protocol or a small computer system interface protocol command. That is, TCG protocols and/or SCSI security PROTOCOL IN/OUT commands can be used, which can act an interface between a SED host system and the SED drive. They can be used to configure/set security settings on the SED disk

In some examples, operation 1006 comprises setting the authentication key and the recovery key for the self-encrypting drive as one operation. That is, where multiple keys are used with a SED, they can be set by providing a list of the multiple keys, e.g., “[AK, RK],” where the AK is the first key in the list and the RK is the second key in the list.

After operation 1006, process flow 1000 moves to operation 1008.

Operation 1008 depicts storing a first value of a maximum number of permitted failed attempts to access the data of the self-encrypting drive, and a second value of a number of failed attempts made to access the data on the self-encrypting drive. In some examples, operation 1008 can be implemented in a similar manner as operations 910-912 of FIG. 9.

After operation 1008, process flow 1000 moves to operation 1010.

Operation 1010 depicts, in response to determining that the first value is greater than the second value, denying an attempt to access the data of the self-encrypting drive with the recovery key. In some examples, operation 1010 can be implemented in a similar manner as operation 914 of FIG. 9.

After operation 1010, process flow 1000 moves to operation 1012.

Operation 1012 depicts, in response to determining that the first value is not greater than the second value, allowing the attempt to access the data of the self-encrypting drive with the recovery key. In some examples, operation 1012 can be implemented in a similar manner as operation 916 of FIG. 9.

In some examples, the attempt comprises a first input value, the first input value is compared to the authentication key, and the first input value is compared to the recovery key after comparing the first input value is compared to the authentication key, and based on the first input value being determined to differ from the authentication key. That is, in a multi-choice authentication mechanism (e.g., where either just the AK (and not the RK) or just the RK (and not the AK) can be used to decrypt the MEK) can comprise authentication according to a priority order. For example, first an input value can be compared against the AK. And if access via the AK fails for a configurable number of attempts, then an input value can be compared against the RK (e.g., auth1-AK OR auth2-RK).

After operation 1012, process flow 1000 moves to 1014, where process flow 1000 ends.

FIG. 11 illustrates an example process flow 1100 that can facilitate multi-choice authentication for data recovery, in accordance with an embodiment of this disclosure. In some examples, one or more embodiments of process flow 1100 can be implemented by multi-choice authentication for data recovery component 108 of FIG. 1, or computing environment 1200 of FIG. 12.

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of one or more of process flow 900 of FIG. 9, and/or process flow 1000 of FIG. 10.

Process flow 1100 begins with 1102, and moves to operation 1104.

Operation 1104 depicts encrypting a first key with a second key, wherein the first key is usable to encrypt data of a storage device. In some examples, operation 1104 can be implemented in a similar manner as operations 904-906 of FIG. 9, where the first key is a media access key, and the second key is an authentication key.

After operation 1104, process flow 1100 moves to operation 1106.

Operation 1106 depicts encrypting the first key with a third key, wherein the first key is able to decrypted with either the second key or the third key. In some examples, operation 1106 can be implemented in a similar manner as operation 908 of FIG. 9, where the third key is a recovery key.

In some examples, a valid attempt to access the data of the storage device with the second key comprises using the second key to access the first key, and using the first key to access the data, and wherein the valid attempt to access the data of the storage device with the second key occurs independently of the valid attempt identifying the third key. That is, the AK (without the RK) can be used to decode the MEK, which can be used to access SED data.

In some examples, a valid attempt to access the data of the storage device with the third key comprises using the third key to access the first key, and using the first key to access the data, and wherein the valid attempt to access the data of the storage device with the third key occurs independently of the valid attempt identifying the second key. That is, the RK (without the AK) can be used to decode the MEK, which can be used to access SED data.

After operation 1106, process flow 1100 moves to operation 1108.

Operation 1108 depicts storing a first value representative of an upper limit on number of permitted failed attempts to access the data of the storage device, and a second value representative of a number of failed attempts that have been made to access the data on the storage device. In some examples, operation 1108 can be implemented in a similar manner as operations 910-912 of FIG. 9.

In some examples, the first value is stored in a counter of the storage device, and a maximum value indicated by the counter is configurable based on user input data. This can be similar to a SED counter tryLimit (or AK attempts required 118 and/or number of unsuccessful AK attempts 120 of FIG. 1). This can be a configurable counter that defines and accepts a maximum number of invalid authentication attempts with the AK.

After operation 1108, process flow 1100 moves to operation 1110.

Operation 1110 depicts, based on the first value being determined to be greater than the second value, denying an attempt to access the data of the storage device with the third key. In some examples, operation 1110 can be implemented in a similar manner as operation 914 of FIG. 9.

After operation 1110, process flow 1100 moves to operation 1112.

Operation 1112 depicts, based on the first value being determined not to be greater than the second value, allowing the attempt to access the data of the storage device with the third key. In some examples, operation 1112 can be implemented in a similar manner as operation 916 of FIG. 9.

In some examples, the allowing of the attempt to access the data of the storage device with the third key comprises rendering a third value of the second key invalid for purposes of accessing the data of the storage device.

In some examples, operation 1112 comprises changing the third value of the second key based on a fourth value of the third key, to produce a fifth value of the second key, wherein the fifth value of the second key is valid for purposes of accessing the data of the storage device.

After operation 1112, process flow 1100 moves to 1114, where process flow 1100 ends.

### Example Operating Environment

In order to provide additional context for various embodiments described herein, FIG. 12 and the following discussion are intended to provide a brief, general description of a suitable computing environment 1200 in which the various embodiments of the embodiment described herein can be implemented.

For example, parts of computing environment 1200 can be used to implement one or more embodiments of computer system 102, and/or user computer system 106.

In some examples, computing environment 1200 can implement one or more embodiments of the process flows of FIGS. 9-11 to facilitate multi-choice authentication for data recovery.

While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a nonvolatile storage such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 139 4 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 139 4 serial port, a game port, a USB port, an IR interface, a BLUETOOTH® interface, etc.

A monitor 1246 or other type of display device can also be connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are examples, and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
encrypting data of a self-encrypting drive with a media encryption key that is stored on the self-encrypting drive;
encrypting the media encryption key with an authentication key;
encrypting the media encryption key with a recovery key, wherein the media encryption key is able to be decrypted with either the authentication key or the recovery key;
storing, on the self-encrypting drive, a first value that indicates a maximum number of permitted failed attempts to access the data of the self-encrypting drive;
storing, on the self-encrypting drive, a second value that indicates a number of failed attempts made to access the data on the self-encrypting drive;
in a first case where the first value is determined to be greater than the second value, denying a first attempt to access the data of the self-encrypting drive with the recovery key, and permitting a second attempt to access the data of the self-encrypting drive with the authentication key; and
in a second case where the first value is determined not to be greater than the second value, allowing the first attempt to access the data of the self-encrypting drive with the recovery key.

2. The system of claim 1, wherein the denying of the first attempt to access the data of the self-encrypting drive with the recovery key comprises:
incrementing the second value.

3. The system of claim 1, wherein the allowing of the first attempt to access the data of the self-encrypting drive with the recovery key comprises:
rendering the authentication key invalid for use in accessing the data of the self-encrypting drive.

4. The system of claim 3, wherein the authentication key is a first authentication key, and wherein the operations further comprise:
based on the recovery key, generating a second authentication key that is valid for use in accessing the data of the self-encrypting drive.

5. The system of claim 4, wherein the recovery key is a first recovery key, and wherein the operations further comprise:
after generating the second authentication key, generating a second recovery key and replacing the first recovery key with the second recovery key.

6. The system of claim 5, wherein the generating of the second recovery key is based on a third value received via user input.

7. The system of claim 1, wherein the permitting of the second attempt to access the data of the self-encrypting drive with the authentication key comprises:
resetting the second value.

8. A method, comprising:
encrypting, by a system comprising at least one processor, a media encryption key with an authentication key, wherein the media encryption key encrypts data of a self-encrypting drive, and wherein the media encryption key is stored on the self-encrypting drive;
encrypting, by the system, the media encryption key with a recovery key, wherein either the authentication key or the recovery key is usable to decrypt the media encryption key;
storing, by the system, a first value of a maximum number of permitted failed attempts to access the data of the self-encrypting drive, and a second value of a number of failed attempts made to access the data on the self-encrypting drive;
in response to determining that the first value is greater than the second value, denying, by the system, an attempt to access the data of the self-encrypting drive with the recovery key; and
in response to determining that the first value is not greater than the second value, allowing, by the system, the attempt to access the data of the self-encrypting drive with the recovery key.

9. The method of claim 8, further comprising:
encrypting at least a first portion of the data with the media encryption key when writing the at least the first portion of the data to the self-encrypting drive; and
decrypting at least a second portion of the data with the media encryption key when reading the at least the second portion of the data to the self-encrypting drive.

10. The method of claim 8, wherein the system is a first storage system, and wherein functionality to offer data protection using the media encryption key is disabled when the self-encrypting drive is moved from the first storage system to a second storage system.

11. The method of claim 8, further comprising:
based on powering on the self-encrypting drive, locking, by the system, the self-encrypting drive; and
in response to receiving the authentication key, unlocking, by the system, the self-encrypting drive.

12. The method of claim 8, further comprising:
setting, by the system, the authentication key and the recovery key for the self-encrypting drive based on a trusted computing group protocol or a small computer system interface protocol command.

13. The method of claim 8, further comprising:
setting, by the system, the authentication key and the recovery key for the self-encrypting drive as one operation.

14. The method of claim 8, wherein the attempt comprises a first input value, wherein the first input value is compared to the authentication key, and
wherein the first input value is compared to the recovery key after comparing the first input value is compared to the authentication key, and based on the first input value being determined to differ from the authentication key.

15. A non-transitory computer-readable medium comprising instructions that, in response to execution, cause a system comprising at least one processor to perform operations, comprising:
encrypting a first key with a second key, wherein the first key is usable to encrypt data of a storage device;
encrypting the first key with a third key, wherein the first key is able to decrypted with either the second key or the third key;
storing a first value representative of an upper limit on number of permitted failed attempts to access the data of the storage device, and a second value representative of a number of failed attempts that have been made to access the data on the storage device;
based on the first value being determined to be greater than the second value, denying an attempt to access the data of the storage device with the third key; and
based on the first value being determined not to be greater than the second value, allowing the attempt to access the data of the storage device with the third key.

16. The non-transitory computer-readable medium of claim 15, wherein the first value is stored in a counter of the storage device, and wherein a maximum value indicated by the counter is configurable based on user input data.

17. The non-transitory computer-readable medium of claim 15, wherein a valid attempt to access the data of the storage device with the second key comprises using the second key to access the first key, and using the first key to access the data, and wherein the valid attempt to access the data of the storage device with the second key occurs independently of the valid attempt identifying the third key.

18. The non-transitory computer-readable medium of claim 15, wherein a valid attempt to access the data of the storage device with the third key comprises using the third key to access the first key, and using the first key to access the data, and wherein the valid attempt to access the data of the storage device with the third key occurs independently of the valid attempt identifying the second key.

19. The non-transitory computer-readable medium of claim 15, wherein the allowing of the attempt to access the data of the storage device with the third key comprises:
rendering a third value of the second key invalid for purposes of accessing the data of the storage device.

20. The non-transitory computer-readable medium of claim 19, wherein the operations further comprise:
changing the third value of the second key based on a fourth value of the third key, to produce a fifth value of the second key, wherein the fifth value of the second key is valid for purposes of accessing the data of the storage device.
